(19) United States
(12) Patent Application Publication
(10) Pub. No.: US 2008/0032543 A1
(43) Pub. Date: Feb. 7, 2008

(54) Universal joint cord protector for hand held hair dryer

(76) Inventor: Vito James Carlucci, Stratford, CT (US)

Correspondence Address: Lawrence Cruz;Conair Corporation, One Cummings Point Road, STAMFORD, CT, 06902, US

(21) Appl. No.: 11/499,579

(22) Filed: Aug. 4, 2006

(51) Int. Cl. H01R 13/56

(52) U.S. Cl. 439/445

(57) ABSTRACT

An electrical cord coupling (1) for use in a hand held appliance such as a hair dryer (19) has a unitary body comprising a sheath-like portion surrounding an electrical cord (8) and a semi-spherical coupling end (5) adapted to be nested into a receptacle (18) in a manner permitting universal rotation of the coupling end relative to the receptacle, while safely and securely maintaining an electrical cord extending therethrough.

### CROSS-REFERENCE TO RELATED APPLICATIONS

None.

### BACKGROUND OF THE INVENTION

1. Field of the Invention

The present invention relates to hair appliances and, more particularly, to an electrical cord swivel coupling for a hand held hair dryer.

2. Description of Related Art

Various small and portable electrical appliances such as hand held hair dryers have dedicated electrical cords for supplying electrical energy from an external source to the appliance. The coupling at which the electrical cord is attached to the appliance is such that the cord is subject to wear from bending and stress concentration. A typical solution is to surround the cord with a flexible boot or sheath beginning at the point of exit from the appliance and extending around the cord for a length of a few inches. Another solution is to provide a swiveling coupling for the cord where the cord is supported for rotation about an axis at a location approximately coincident with the outer wall of the appliance from where the cord extends. A swiveling coupling, especially if used in combination with a boot or sheath, can provide better protection against wear than a boot or sheath alone. Such swiveling couplings are, however, relatively complex and expensive, as they require a dynamic contact that is electrically conductive.

It is desirable to provide a solution for preventing or reducing wear at the coupling of a cord extending from an appliance wall for a hand held or portable appliance such as a hair dryer.

### OBJECTS OF THE PRESENT INVENTION

It is an object of the present invention to provide an electrical cord coupling for use in an electrical portable or hand held appliance that economically, safely and durably achieves wear-resistance.

These and other objects are achieved by the present invention.

### BRIEF SUMMARY OF THE PRESENT INVENTION

According to the present invention, an electrical cord coupling for use in a hand held appliance such as a hair dryer has a unitary body comprising a sheath-like portion surrounding an electrical cord and a semi-spherical coupling end adapted to be nested into a receptacle in a manner permitting universal rotation of the coupling end relative to the receptacle, while safely and securely maintaining an electrical cord extending therethrough.

### BRIEF DESCRIPTION OF THE DRAWINGS

FIG. 1 is a side view of a device according to a preferred embodiment of the present invention.

FIG. 2 is a cross-sectional side view of a device according to a preferred embodiment of the present invention.

### DETAILED DESCRIPTION OF THE PREFERRED EMBODIMENT OF THE INVENTION

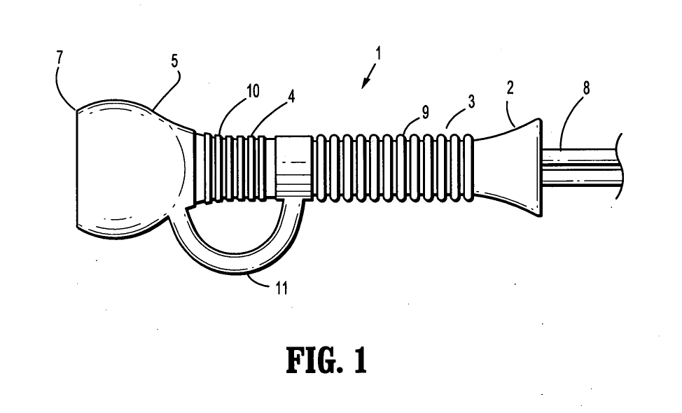

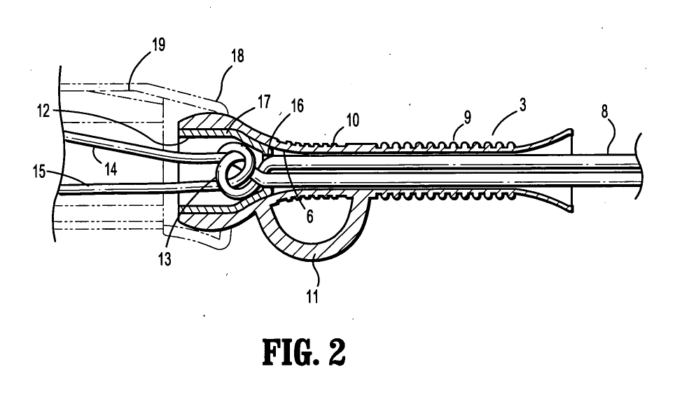

An electrical cord coupling (1) according to the present invention is shown in FIGS. 1-2. The (1) is comprised of a unitary body that can be molded of plastic or rubber, or another suitable material that is preferably non-conductive electrically, and that has a distal end (2), a first intermediate section (3), a second intermediate section (4), and a semi-spherical section (5) at a proximal end (7). The coupling (1) has an internal passage (6) extending through in a direction connecting its distal end (2) and its proximal end (7). The distal end (2) is preferably flared to permit bending or pivoting of an electrical cord (8) extending therefrom. The first intermediate section (3) can be provided with ridges (9) to provide strength and flexibility at the same time. The second intermediate section (4) can also be provided with ridges (10), preferably of a different profile than ridges (9) and being selected to permit less flexing and to achieve greater strength, so that the coupling is gradually stronger and less flexible going from the distal end (2) to the proximal end (7). A hook (11) may be provided for hanging the appliances from a nail or hook when it is not in use. The semi-spherical section (5) is formed generally in the shape of a sphere except that an end section of approximately ¼ of the sphere is cut away at the proximal end (7). The cut-away portion at the proximal end allows the end opening (12) to have a relatively large diameter so that proximal portion (14, 15) of the electrical cord (8) can move relative to the opening (12) without interference when the coupling (1) is swiveled relative to the appliance it is mounted to. The cord (8) may be separated into two components (14, 15) and tied in a knot (13) to prevent it from being pulled out through the opening (16) of an internal sleeve (17). The cord (8) conducts electricity from an external power source (not shown) to the hair dryer (19). The internal sleeve (17) maintains the shape of the semi-spherical section (5) to hold it in place inside of the appliance receptacle (18) formed in the appliance wall. The outer surface of the semi-spherical portion (5) contacts and slides relative to the appliance receptacle (18) allowing the coupling (1) to pivot relative to the appliance during use. The relatively large diameter of the end opening (12) prevents the cord components (14, 15) from being pinched or contacted by the proximal ends of the semi-spherical section (5) and the internal sleeve (17) during such pivoting. The pivoting motion facilitated by the coupling (1) is universal, such as in a ball-joint.

While a preferred embodiment of the present invention has been shown and described herein, it is understood that various modification can be made without departing from the scope of the present invention.

What is claimed is:

1) An electrical cord coupling for use in a hand held hair dryer, said coupling comprising
a body having a proximal end, a distal end, and an intermediate section;
an internal passage through said body extending in a direction from said proximal end to said distal end;
a semi-spherical section located at said proximal end;
a receptacle on said hair dryer receiving said semi-spherical section in a pivoting relationship; and
an electrical cord passing through said body and through said receptacle for conducting electricity from an external power source to said hair dryer.

2) A coupling according to claim 1, wherein
said internal passage has a greater internal diameter at said proximal end than at said intermediate section.

3) A coupling according to claim 1, wherein
said electrical cord is knotted at a location in said internal passage approximately within said semi-spherical section.

4) A coupling according to claim 1, wherein
said coupling body is a unitary body.
